(19) United States
(12) Patent Application Publication
(10) Pub. No.: US 2006/0230900 A1
(43) Pub. Date: Oct. 19, 2006

(54) Chain saw tensioning device

(75) Inventor: Oskar Bergquistö, Jonkoping (SE)

Correspondence Address: PEARNE & GORDON LLP, 1801 EAST 9TH STREET, SUITE 1200, CLEVELAND, OH, 44114-3108, US

(73) Assignee: Aktiebolaget Electrolux, Stockholm (SE)

(21) Appl. No.: 10/547,037

(22) PCT Filed: Mar. 4, 2004
(86) PCT No.: PCT/SE04/00313

§ 371 Date: May 8, 2006

(30) Foreign Application Priority Data
Mar. 6, 2003 (SE) 0300611-1

(51) Int. Cl. B26D 5/42

(52) U.S. Cl. 83/381

(57) ABSTRACT

This invention relates to a chain saw comprising an engine body on which a guide bar is arranged such that it can be moved in its length direction. The chain saw is provided with a saw chain tensioning device (16) which is operated manually without the aid of separate tools. The tensioning device comprises a screw (19) extending mainly parallel to the length direction of the guide bar. A chain tensioning nut is arranged on the screw such that the chain tensioning nut co-operates with the guide bar in order to tension the chain. The screw (19) is connected to the output shaft of a gear (20, 25) whose input shaft is connected to a tensioning wheel (26) accessible for manual adjustment from the outside of the chain saw without separate tools.

This invention relates to a chain saw comprising an engine body on which a guide bar is arranged such that it can be moved in its length direction the saw being provided with a saw chain tensioning device which is operated manually without the aid of separate tools and comprising a chain tensioning screw extending in the length direction of the guide bar and on which a chain tensioning nut is arranged such that the nut co-operates with the guide bar in order to tension the chain.

As the links in the cutting chain of a chain saw wear with use the chain streches and becomes loose on the guide bar. Many methods exist to move the guide bar longitudinally away from the chain saw body and the drive sprocket to take the slack out of the links of the cutting chain to ensure that the links of the chain remain seated and ride in a perhiperal channel in the guide bar. A number of methods require the operator to physically move the guide bar longitudinally from the engine body to a tensioned position by means of specific tools and then employ a separate tool to physically tighten the assembly so that the bar will remain in the new position.

In order to avoid the use of separate tools this invention provides an easily accessible, simple and reliable means for manually tensioning the chain. This is achieved by means of a device having the characteristics mentioned in the claims.

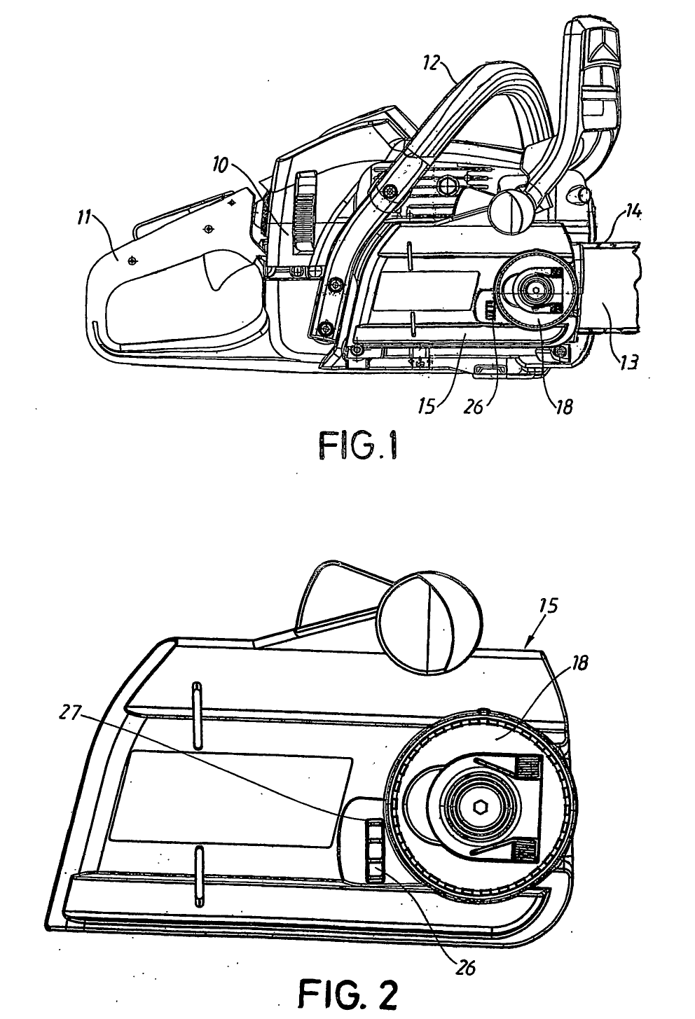

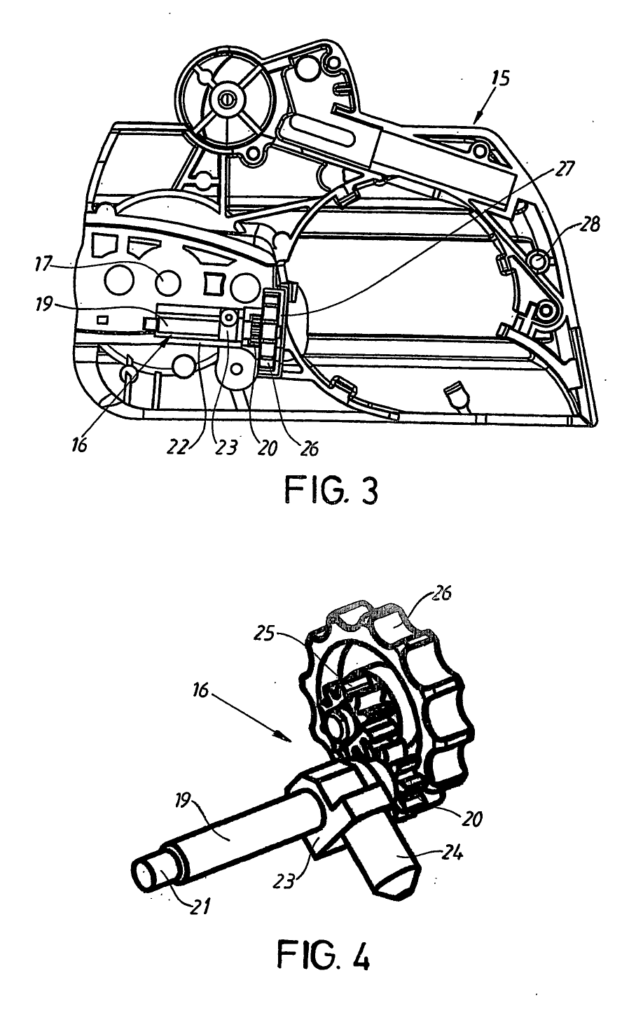

An embodiment of the invention will now be described with reference to the accompanying drawings on which FIG. 1 is a partly broken side view of a chain saw provided with the arrangement according to the invention, FIG. 2 is a front view of a clutch cover housing the arrangement, FIG. 3 is a rear view of the clutch cover shown in FIG. 2 and FIG. 4 is a perspective view of the tensioning arrangement.

The chain saw shown in FIG. 1 comprises an engine body 10 with handles 11 and 12 and a chain saw guide bar 13 that in a conventional manner supports a saw chain 14 driven by means of a sprocket hidden under a clutch cover 15. The engine body is provided with a combustion engine, an electric motor or some other type of driving source that drives the sprocket wheel.

The guide bar 13 is by means of a chain tensioning mechanism 16, see FIG. 3, and a guiding arrangement, not shown, slidably arranged in its length direction in order to make it possible to take the slacks out of the links of the saw chain 14 when moving the guide bar outwards from the engine body 10. The engine body is provided with a bar bolt extending perpendicular to a guide bar plane arranged at the body and through an slot in the guide bar and further through an opening 17 in the clutch cover 15. The guide bar 13 is clamped between the clutch cover 15 and the engine body 10 by means of a nut, not shown, which is connected to a tightening wheel 18 that is accessible from the outside of the clutch cover.

The tensioning mechanism 16, see FIG. 4, comprises a screw rod 19 that is mainly parallel to the length direction of the guide bar 13. The screw rod has a first gear wheel 20 at one end whereas the other end 21 is turnably supported at the end of an elongated pocket 22 that is arranged in the clutch cover 15 and encloses the mechanism 16. The screw rod 19 supports a threaded chain tensioning nut 23 that is arranged to slide along the pocket 22 and that is provided with a pin 24 extending into an opening in and being in engagement with the guide bar 13. The first gear wheel 20 is in engagement with a second gear wheel 25 arranged to be turned about an axis parallel to the screw rod 19 and being an integrated part of a tensioning wheel 26. The tensioning wheel is supported at the other end of the elongated pocket 22 such that the outer portion of the tensioning wheel extends through an opening 27 in the clutch cover 15 making it possible to manually turn the tensioning wheel from the outside of the clutch cover. In order to prevent the clutch cover 15 to move with respect to the engine body 10 when the operator has loosened the bar bolt nut by means of the tightening wheel 18 the clutch cover and/or the engine body is provided with one or several projections 28 which are in engagement with corresponding recesses in the engine body and/or the clutch cover.

The tensioning device operates in the following manner. When there is a slack in the chain the operator turns the tightening wheel 18 such that the nut clamping the clutch cover 15 and the guide bar 13 to the engine body 10 is loosened. Then the operator turns the tensioning wheel 26 with one of his fingers whereby the turning motion is transmitted to the screw rod 19 by means of the gear wheels 20, 25. The threaded engagement between the screw rod 19 and the chain tensioning nut 23 with the pin 24 causes the chain tensioning nut to move in the length direction of the pocket 16 such that the guide bar is pushed outwards from the engine body thereby tensioning the chain 14. When a proper position has been reached the operator locks the guide bar in the new position by clamping the clutch cover 15 against the guide bar with the aid of the tightening wheel 18.

1. Chain saw comprising an engine body (10) on which a guide bar (13) is arranged such that it can be moved in its length direction the chain saw being provided with a saw chain tensioning device (16) which is operated manually without the aid of separate tools and comprises a screw (19) extending mainly parallel to the length direction of the guide bar (13) and on which a chain tensioning nut is arranged such that the chain tensioning nut co-operates with the guide bar in order to tension the chain (14) characterized in that the screw (19) is connected to the output shaft of a gear (20,25) whose input shaft is connected to a tensioning wheel (26) accessible for manual adjustment from the outside of the chain saw without separate tools.

2. Chain saw according to claim 1 characterized in that the input and output shaft are mainly parallel to the length direction of the guide bar (14).

3. Chain saw according to claim 1 or 2 characterized in that the chain tensioning nut (23) is provided with an projection (24) which is in engagement with the guide bar (13).

4. Chain saw according to claim 1 characterized in that the gear (20,25), the tensioning wheel (26), the screw (19) and the chain tensioning nut (23) are integrated into a support unit which is removably arranged on the engine body.

5. Chain saw according to claim 3 characterised in that the support unit is designed as a cover (15) that serves as a clamping means for the guide bar.
